(19) United States
(12) Patent Application Publication
(10) Pub. No.: US 2022/0163871 A1
(43) Pub. Date: May 26, 2022

(54) LENS STRUCTURE AND PHOTOGRAPHIC DEVICE

(71) Applicant: IVIEW DISPLAYS (SHENZHEN) COMPANY LTD., Shenzhen (CN)

(72) Inventors: Zhiwei Hu, Shenzhen (CN); Steve Yeung, Hong Kong (CN); Zhiqiang Gao, Hong Kong (CN); Mingnei Ding, Shenzhen (CN); Yuan Zhao, Shenzhen (CN)

(21) Appl. No.: 17/584,495

(22) Filed: Jan. 26, 2022

Related U.S. Application Data
(63) Continuation of application No. PCT/CN2019/129519, filed on Dec. 28, 2019.

(30) Foreign Application Priority Data
Jul. 29, 2019 (CN) 201921221807.2

(51) Int. Cl. G03B 13/36

(52) U.S. Cl. CPC G03B 13/36

(57) ABSTRACT

The present disclosure provides a lens structure and a photographic device. The lens structure includes a lens barrel, a ball assembly, and a sleeve. The ball assembly is disposed on an outer surface of the lens barrel. The sleeve receives the lens barrel and the ball assembly. The sleeve is in rolling contact with the lens barrel via the ball assembly.

### CROSS-REFERENCE TO RELATED APPLICATIONS

This application is a continuation-application of International (PCT) Patent Application No. PCT/CN2019/129519, filed on Dec. 28, 2019, which claims priority to Chinese Patent Application No. 201921221807.2, filed with the National Intellectual Property Administration of China on Jul. 29, 2019, and entitled “LENS STRUCTURE”, the entire contents of which are incorporated herein by reference.

### TECHNICAL FIELD

The present disclosure relates to the technical field of optical engines, and in particular, relates to a lens structure and a photographic device.

### BACKGROUND

With constant developments of optoelectronic technologies, more and more optical engine devices are coming into the market. People are imposing higher and higher requirements on the optical engine devices, and optical engine devices having smaller electricity rating and smaller size are desired. In optical engine devices having the automatic focusing function, a major factor restricting miniaturization of the optical engine devices is the size of focusing motors. Therefore, mutual restriction between the size of the optical engine device and a push force of the motor is a challenge to be addressed.

In a conventional optical engine device having the automatic focusing function, a lens barrel is in direct contact with a sleeve, and during focusing, a greater direct friction is present between the lens barrel and the sleeve. As a result, a larger-sized motor is desired such that a greater push force is provided so as to achieve automatic focusing.

### SUMMARY

An embodiment of the present disclosure provides a lens structure. The lens structure includes: a lens barrel; a ball assembly, disposed on an outer surface of the lens barrel; and, a sleeve, receiving the lens barrel and the ball assembly, and being in rolling contact with the lens barrel via the ball assembly.

Another embodiment of the present disclosure provides a photographic device. The photographic device includes a lens structure. The lens structure includes: a lens barrel; a ball assembly, disposed on an outer surface of the lens barrel; and, a sleeve, receiving the lens barrel and the ball assembly, and being in rolling contact with the lens barrel via the ball assembly.

### BRIEF DESCRIPTION OF THE DRAWINGS

One or more embodiments are illustrated by way of example, and not by limitation, in the FIGURES of the accompanying drawings, wherein components having the same reference numeral designations represent like components throughout. The drawings are not to scale, unless otherwise disclosed.

FIG. 1 is a schematic structural view of a lens structure according to an embodiment of the present disclosure.

### DETAILED DESCRIPTION

For better understanding of the present disclosure, the present disclosure is described in detail with reference to attached drawings and specific embodiments. It should be noted that, when an element is defined as “being fixedly disposed on” another element, the element may be directly positioned on the element or one or more centered elements may be present therebetween. When an element is defined as “being connected or coupled to” another element, the element may be directly connected or coupled to the element or one or more centered elements may be present therebetween. In the description of the present disclosure, it should be understood that the terms “upper,” “lower,” “inner,” “outer,” “vertical,” “horizontal,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure. In addition, the terms “first,” “second,” and the like are merely for the illustration purpose, and shall not be construed as indicating or implying a relative importance.

Unless the context clearly requires otherwise, throughout the specification and the claims, technical and scientific terms used herein denote the meaning as commonly understood by a person skilled in the art. Additionally, the terms used in the specification of the present disclosure are merely for description of the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

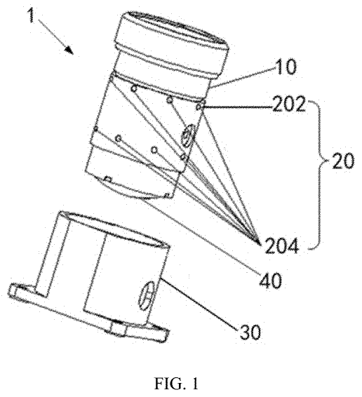

Referring to FIG. 1, an embodiment of the present disclosure provides a lens structure 1. The lens structure 1 includes a lens barrel 10, a ball assembly 20, and a sleeve 30. The ball assembly 20 is disposed on an outer surface of the lens barrel 10. The sleeve 30 is mainly configured to receive the lens barrel 10 and the ball assembly 20, and the sleeve 30 is in rolling contact with the lens barrel 10 via the ball assembly 20. In this way, resistance between the sleeve and the lens barrel may be reduced.

In an embodiment of the present disclosure, the lens barrel 10 may be a refractive lens barrel. The refractive lens barrel is constituted by a focusing assembly, a lens barrel group, an object lens group, and a light-shielding cover, and is configured to reduce chromatic aberration. It may be understood that in some other embodiments, the lens barrel 10 may be replaced by a reflective lens barrel or a catadioptric lens barrel. The reflective lens barrel is constituted by a primary reflective lens group, a lens barrel group, a focusing assembly, and a secondary reflective lens group; and the catadioptric lens barrel is constituted by a primary reflective lens group, a lens barrel group, a focusing assembly, a correction lens, and a secondary reflective lens group.

Specifically, during focusing, the sleeve 30 is in rolling friction with the lens barrel 10 via the ball assembly 20, such that conventional friction fashion between the sleeve 30 and the lens barrel 10 is changed. In this way, resistance against the focusing is reduced, and thus automatic focusing may be achieved by using an even smaller-sized motor.

In some embodiments, the ball assembly 20 includes a retaining frame 202 and a ball 204.

The retaining frame 202 is sleeved onto the outer surface of the lens barrel 10, and the retaining frame 202 is made of a rigid material and thus achieves a good support force. The retaining frame 202 is provided with a through hole, wherein the ball 204 is disposed in the through hole, and the ball 204 is in contact with both the lens barrel 10 and the sleeve 30. Specifically, the retaining frame 202 is provided with at least one through hole configured to receive the ball 204. The ball 204 is in one-to-one correspondence with the through hole in the retaining frame 202. A width of the through hole is adaptive to a diameter of the ball 204. The ball 204 is disposed in the through hole, and is in contact with both the lens barrel 10 and the sleeve 30. That is, the ball 204 may roll in the through hole of the retaining frame 202 by leaning against a surface of the lens barrel 10, and may roll by attaching on a surface of the inner wall of the sleeve 30. In this way, the resistance between the sleeve 30 and the lens barrel 10 is reduced. The ball 204 is subjected to surface polishing and thermal treatment, and thus has the characteristic of smooth surface and friction resistance, such that performance and life time of the ball 204 are improved.

In some embodiments, the lens barrel 10 and the retaining frame 202 are in clearance fit to each other. Clearance fitting may effectively compensate for an error between the lens barrel 10 and the retaining frame 202, and cause contact surfaces that are in mutual friction to be isolated from each other to effectively reduce friction. The retaining frame 202 is a hollow cylinder. It may be understood that in some other embodiments, the retaining frame 202 may also be in other shapes, as long as it is ensured that the retaining frame 202 and the lens barrel 10 are substantially approximate in terms of shape.

In some other embodiments, the sleeve 30 is provided with a receiving chamber, wherein the lens barrel 10 and the ball assembly 20 are received in the receiving chamber of the sleeve 30. The sleeve 30 is made of a rigid material, and thus achieves a support force and facilitates shaping. The sleeve 30 has a smooth inner wall. A lubricating oil may be applied to the inner wall of the sleeve 30, wherein the lubricating oil may cause the ball 204 to roll on the inner wall of the sleeve 30 more smoothly.

In some embodiments, the ball 204 has a diameter of 1 mm, and a tolerance of ±5 μm. The ball 204 may be made of a glass material or a metal material, and at least one ball 204 is configured. It may be understood that the material and the number of balls 204 are not limited, but may be customized according to the actual needs, as long as it is ensured that the number of balls 204 is consistent with the number of through holes, which are not limited to the configurations in this embodiment.

In some embodiments, the lens structure 1 further includes a lens 40, wherein the lens 40 is received in the lens barrel 10. Specifically, the lens 40 may be an optical lens (for example, a 180-mm macro optical lens from Canon). Such an optical lens is capable of receiving an optical object and adjusting the same, thereby achieving optical imaging. The optical lens may be a short-focus lens, a middle-focus lens, or a long-focus lens in terms of a focal length; the optical lens may be a wide-angle lens, a standard lens, or a telephoto lens in terms of a magnitude of a field of view; and the optical lens may be a fixed-aperture fixed-focus lens, a manual-aperture fixed-focus lens, an automatic-aperture fixed-focus lens, a manual focusing lens, an automatic-aperture motorized zoom lens, a motorized zoom lens, or the like in terms of structure. The lens 40 may be made of a material that is partially or completely reflective or penetrative. Typically, the material includes glass or plastic. During taking an image by the optical lens, a side, proximal to an object to be shot, on a light path is an enlargement side, and a side, proximal to a photosensitive element, on the light path is a reduction side. It may be understood that in some other embodiments, the lens 40 may be other ordinary lens. It should be noted that the lens 40 is a lens well known to a person skilled in the art, and has all the functions of the lens. A suitable lens may be selected according to actual needs, and the lens is not limited to that described in this embodiment.

The lens structure 1 according to the embodiments of the present disclosure is applicable to any device where the resistance between the sleeve and the lens barrel needs to be reduced, or any device where automatic focusing needs to be achieved by using a small-sized motor, for example, a photographic device, a video recording device, or the like. In practice, the lens structure 1 may replace the traditional lens barrel and sleeve, and may be directly disposed on the photographic device or the video recording device. The sleeve is in rolling contact with the lens barrel via the ball assembly, such that the resistance between the sleeve and the lens barrel is reduced. In this way, automatic focusing is achieved by using an even smaller-sized motor.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

1. A lens structure, comprising:
a lens barrel;
a ball assembly, disposed on an outer surface of the lens barrel; and
a sleeve, receiving the lens barrel and the ball assembly, and being in rolling contact with the lens barrel via the ball assembly.

2. The lens structure according to claim 1, wherein the ball assembly comprises a retaining frame and a ball; the retaining frame is disposed on the outer surface of the lens barrel; and the retaining frame is provided with a through hole, wherein the ball is disposed in the through hole.

3. The lens structure according to claim 2, wherein the lens barrel and the retaining frame are in clearance fit to each other.

4. The lens structure according to claim 3, wherein the ball is in contact with both the lens barrel and the sleeve.

5. The lens structure according to claim 2, wherein the retaining frame is a hollow cylinder.

6. The lens structure according to claim 5, wherein the sleeve has a smooth inner wall.

7. The lens structure according to claim 6, wherein the ball has a diameter of 1 mm, and a tolerance of ±5 μm.

8. The lens structure according to claim 7, wherein at least one ball is disposed.

9. The lens structure according to claim 8, further comprising a lens; wherein the lens is received in the lens barrel.

10. A photographic device, comprising a lens structure; wherein the lens structure comprises:
a lens barrel;
a ball assembly, disposed on an outer surface of the lens barrel; and
a sleeve, receiving the lens barrel and the ball assembly, and being in rolling contact with the lens barrel via the ball assembly.

11. The photographic device according to claim 10, wherein the ball assembly comprises a retaining frame and a ball; the retaining frame is disposed on the outer surface of the lens barrel; and the retaining frame is provided with a through hole, wherein the ball is disposed in the through hole.

12. The photographic device according to claim 11, wherein the lens barrel and the retaining frame are in clearance fit to each other.

13. The photographic device according to claim 12, wherein the ball is in contact with both the lens barrel and the sleeve.

14. The photographic device according to claim 11, wherein the retaining frame is a hollow cylinder.

15. The photographic device according to claim 14, wherein the sleeve has a smooth inner wall.

16. The photographic device according to claim 15, wherein the ball has a diameter of 1 mm, and a tolerance of ±5 μm.

17. The photographic device according to claim 16, wherein at least one ball is disposed.

18. The photographic device according to claim 17, further comprising a lens; wherein the lens is received in the lens barrel.
